(19) United States
(12) Patent Application Publication
(10) Pub. No.: US 2002/0010732 A1
(43) Pub. Date: Jan. 24, 2002

(54) Parallel processes run scheduling method and device and computer readable medium having a parallel processes run scheduling program recorded thereon

(76) Inventors: Kenji Matsui, Yokohama (JP); Kazumasa Tobe, Yokohama (JP); Masahiko Nagata, Yokohama (JP); Hiroyuki Kumazaki, Yokohama (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/883,173

(22) Filed: Jun. 19, 2001

(30) Foreign Application Priority Data
Jun. 19, 2000 (JP) 2000-182554

(51) Int. Cl. G06F 9/00

(52) U.S. Cl. 709/107

(57) ABSTRACT

The parallel processes run scheduling method, disclosed herein, reduces the overhead due to scheduling by coordinating the processing steps of the processors, not requiring explicit processor-to-processor communication. When being requested to activate or deactivate a parallel program, the parallel program manager commands the process queue managers on the processors to generate or remove the allocated process of the program. On each processor, in obedience to the command, the process queue manager enqueues or remove the process into or from the process queue. Each processor is equipped with a processes number counter to store the number of processes to run on the processor, corresponding to the number of parallel programs activated and an integrating counter that increments over time in synchronization with all other processors. Out of the processes in the process queue, a process to execute is determined to be n-th process from the beginning of the process queue, where n is obtained by “(the value of the integrating counter /time slice) mod the value of the processes number counter.” During a time slice, one process is to be executed.

### FIELD OF THE INVENTION

In a parallel-processing computers system comprising a plurality of processors interconnected via a connecting network, the present invention relates to scheduling the run of parallel processes in an information processing system that executes parallel processes of parallel programs operating on the plurality of processors in a time-sharing-based multiplex manner.

### BACKGROUND OF THE INVENTION

A parallel-processing computers system comprises a plurality of processors interconnected and a connecting network interconnecting the processors.

In such system, parallel programs are run on the plurality of processors and each program is divided into multiple parallel processes which are allocated to the separate processors and operate in parallel.

Data exchange via the connecting network takes place among the processes operating in parallel on the plurality of processors and thereby the processes as a whole produce results.

When the parallel processes that are executed in this way are running, they are checked for being synchronized at certain-interval checkpoints.

When one process is running in conjunction with other remote processes running and a checkpoint comes, if any remote process does not reach the check point, data exchange with the remote process is impossible and what is called the wait for synchronization occurs.

When a plurality of parallel programs are executed simultaneously, the entire computers system is used in a time-sharing manner. This method is explained in “Parallel Operating System” by Akira Fukuda, pp. 55-56 (published by Korona-sha, 1997) (ISBN4-339-0258-9).

When a plurality of parallel programs are executed in the time-sharing-based multiplex manner in the parallel-processing computers system, it is necessary to schedule the run of parallel processes on each processor and switch to the next process.

If scheduling the run of parallel processes is performed without coordinating the process-run steps of the plurality of processors, due to the run time difference among the parallel processes executed on the processors, a problem arises that the wait time for synchronizing the parallel processes increases.

To avoid such increase of the wait time for synchronization, in scheduling the run of the parallel processes of parallel programs, it is necessary to coordinate the process-run steps of the processors so that the parallel processes of one of the parallel programs will be executed simultaneously and in turn.

There are some methods of such scheduling for coordinating the processors, one of which is described in (1) “Parallel Operating System” by Akira Fukuda, pp. 5662 (published by Korona-sha, 1997) (ISBN4-339-0258-9). This parallel processes run scheduling method is outlined as follows. The parallel processes of parallel programs are simultaneously executed during a time slice. When the time slice expires, a global scheduler is called. The scheduler selects the next process to execute and notifies the processors of that process.

Another parallel processes run scheduling method is disclosed in (2) JP-A-74150/1998. This scheduling method is outline as follows. To execute the parallel processes of parallel programs, a program allocation table is created, wherein the start time and the end time of a given period for process run are predetermined. After notified of the information specified in this table, the processors execute the processes, according to that information.

### SUMMARY OF THE INVENTION

In the above-described scheduling methods, the step of notifying the processors of necessary information is required, each time switching to the next process is performed in the case of the prior art reference (1) and each time a program allocation table is created or the table is updated in the case of the prior art reference (2).

Therefore, in addition to the processing performed by each individual processor, management processing is required for sending such notification from one processor to other processors. The overhead time due to this management processing is a drawback of the conventional scheduling methods of coordinating the processing steps of the processors.

The object of the present invention is to provide a parallel processes run scheduling method not requiring explicit processor-to-processor communication, thus reducing the overhead due to scheduling by coordinating the processing steps of the processors.

To achieve the above object and in accordance of a first aspect of the present invention, a parallel processes run scheduling method is provided to be used in an information processing system comprising a plurality of processors on which a plurality of parallel programs, each consisting of the equal number of parallel processes, are run in a time-sharing-based multiplex manner.

In this parallel processes run scheduling method, all allocated parallel processes on each processor are executed in order as determined, according to the value of an integrating counter on each processor that increments over time in synchronization with all other processors and the number of the parallel programs to run concurrently in the system, thereby simultaneously executing the parallel processes of one of the parallel programs in turn on the processors.

In accordance of a second aspect of the present invention, a parallel processes run scheduling method is provided to be used in an information processing system comprising a plurality of processors on which a plurality of parallel programs, each consisting of the discrete number of parallel processes, are run in a time-sharing-based multiplex manner.

In this parallel processes run scheduling method, all allocated parallel processes on each processor are executed in order as determined, according to the value of an integrating counter on each processor that increments over time in synchronization with all other processors and the number of the parallel programs to run concurrently in the system, wherein, if the number of the parallel processes of a parallel program is less than the number of processors to be used for running the parallel program in the timesharing-based multiplex manner, some of the processors to which no parallel process of the parallel program is allocated execute a dummy process allocated instead when the parallel program is executed, thereby simultaneously executing the parallel processes of one of the parallel programs in turn on the processors.

In accordance of a third aspect of the present invention, a parallel processes run scheduling device is provided to be used in an information processing system comprising a plurality of processors on which a plurality of parallel programs, each consisting of the equal number of parallel processes, are run in a time-sharing-based multiplex manner.

This device to be provided on each processor comprises:

an integrating count means, the count value of which increments over time in synchronization with all other processors;

a processes number count means to store the number of processes to run on the processor, corresponding to the number of parallel programs to run in the system;

a means for generating a queue of processes to execute;

a process queue buffer means for storing the generated process queue; and

a means for determining a process to execute that determine a process to execute out of the processes in the process queue, according to the count value of the integrating count means and the number of processes retained in the processes number count means.

In accordance of a fourth aspect of the present invention, a parallel processes run scheduling device is provided to be used in an information processing system comprising a plurality of processors on which a plurality of parallel programs, each consisting of the discrete number of parallel processes, are run in a time-sharing-based multiplex manner.

This device to be provided on each processor comprises;

an integrating count means, the count value of which increments over time in synchronization with all other processors;

a processes number count means to store the number of processes to run on the processor, corresponding to the number of parallel programs to run in the system;

a means for generating a queue of processes to execute, wherein, if the number of processes allocated to the processor for executing them is less than the number of processes retained in the processes number count means, the means for generating a queue generates a queue of processes including as many dummy processes as required to fill up the difference in the number of processes of both; if the number of processes of both agrees, the means for generating a queue generates a queue of processes not including dummy processes;

a process queue buffer means for storing the generated process queue; and

a means for determining a process to execute that determine a process to execute out of the processes in the process queue, according to the count value of the integrating count means and the number of processes retained in the processes number count means.

Other and further objects, features and advantages of the invention will appear more fully from the following description.

### BRIEF DESCRIPTION OF THE DRAWINGS

A preferred form of the present invention illustrated in the accompanying drawings in which:

FIG. 1 is a diagram outlining the transition of the processes to be executed on each processor over time, according to the parallel processes run scheduling method of the present invention;

FIG. 2 is a diagram showing an exemplary system of parallel-processing computers in a preferred embodiment of the invention;

FIG. 3 is a schematic representation of the process flow of action to parallel programs in a preferred embodiment of the invention;

FIG. 4 is a diagram giving an example of the transition of the processes to be executed on each processor over time in the first embodiment of the invention;

FIG. 5 is a diagram giving an example of the transition of the processes to be executed on each processor over time, after the parallel processes of parallel programs are generated and allocated in accordance with the scheduling method of the first embodiment of the invention;

FIG. 6 is a diagram giving an example of the transition of the processes to be executed on each processor over time in accordance with the scheduling method of a second embodiment of the present invention;

FIG. 7 is a diagram giving an example of the process queue when the number of processes is two in the first embodiment of the invention;

FIG. 8 is a diagram giving an example of the process queue when the number of processes is three in the first embodiment of the invention;

FIG. 9 is a diagram giving an example of the process queue when the number of processes is two in the second embodiment of the invention;

FIG. 10 is a flowchart illustrating the processing of a process-executing entity in a preferred embodiment of the invention;

FIG. 11 is a flowchart illustrating the processing of a process queue manager in a preferred embodiment of the invention;

FIG. 12 is a flowchart illustrating the processing of a parallel program manger in the first embodiment of the invention; and

FIG. 13 is a flowchart illustrating the processing of the parallel program manger in the second embodiment of the invention.

### DESCRIPTION OF THE PREFERRED EMBODIMENTS

Firstly, the principle of embodying the present invention will be explained.

In accordance with a preferred embodiment of the invention, a parallel-processing computers system comprising a plurality of processors interconnected via a connecting network is assumed. In such system, when a plurality of parallel programs, each consisting of the equal number of parallel processes, are executed in a time-sharing-based multiplex manner, the following scheduling method is applied to execute the processes.

The processors execute the allocated parallel processes as determined by a function f (c, pn) per time slice for each processor during a time slice.

In this function, a value of c is given by the integrating counter that each processor has and a value of pn is the number of processes to be executed on each processor, that is, corresponding to the number of parallel programs running concurrently. The function f (c, pn) is uniquely determined, depending on the value of c and the value of pn.

The function f (c, pn) is used such that when the same value of c and the same value of pn are given for all processors, the parallel processes of one of the parallel programs are determined to run on the processors.

The above integrating counters on all processors in the system are initialized to a value of the same origin when the system reboots and increment over time synchronously for all processors.

At any given time, all processors are given the equal value of the integrating counter c and the equal number of parallel processes pn and the processes determined by f (c, pn) are the parallel processes of one of the parallel programs. In consequence, the parallel processes to be executed on the processors are sequenced correspondingly. Thus, the parallel processes of one of the parallel programs are executed simultaneously and in turn.

In the way described above, the overhead due to scheduling by coordinating the process-run steps of the processors can be reduced and explicit processor-to-processor communication can be made unnecessary.

When a plurality of parallel programs, each consisting of the discrete number of processes, are executed in the time-sharing-based multiplex manner, multiple processors are shared for running the programs. When a processor is not executing a parallel process of one of the parallel programs, instead, it executes a dummy process simultaneously with the parallel processes of the parallel program. In this way, the number of processes executed on each processor is made equal for all processors and the above parallel processes run scheduling method for simultaneously executing the parallel processes of one of the parallel programs in turn is applied.

In the way described above, even if a plurality of parallel programs, each consisting of the discrete number of processes, are executed in the time-sharing-based multiplex manner, the overhead due to scheduling by coordinating the process-run steps of the processors can be reduced and explicit processor-to-processor communication can be made unnecessary.

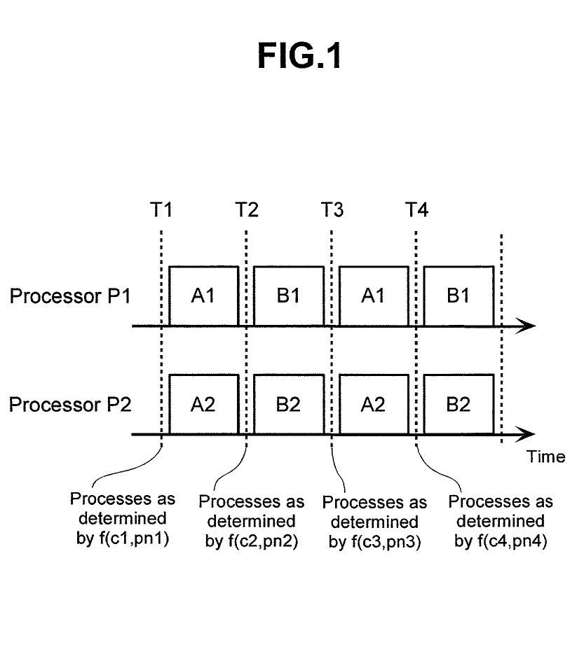

FIG. 1 is a diagram outlining the parallel processes run scheduling to be carried out by the present invention.

In this diagram, two parallel programs, one consisting of two parallel processes A1 and A2 and the other consisting of two parallel processors B1 and B2, are executed on processors P1 and P2.

The processor P1 is responsible for executing the processes A1 and B1, whereas the processor P2 is responsible for executing the processes A2 and B2.

At times T1 to T4, the processors execute processes, A1 and A2, Bi and B2, A1 and A2, and B1 and B2 as determined by f (c1, pn 1), f (c2, pn2), f (c3, pn3), and f (c4, pn4), respectively.

Hereupon, the values of c1 to c4 are given by the integrating counter of each processor at times T1 to T4, correspondingly, and the values of pn1 to pn4 are the number of processes to be executed by each processor at times T1 to T4. These values are equal for the processors P1 and P2.

As represented in FIG. 1, the parallel processes of one of the parallel programs are executed simultaneously in turn.

A preferred embodiment of the present invention will be explained below.

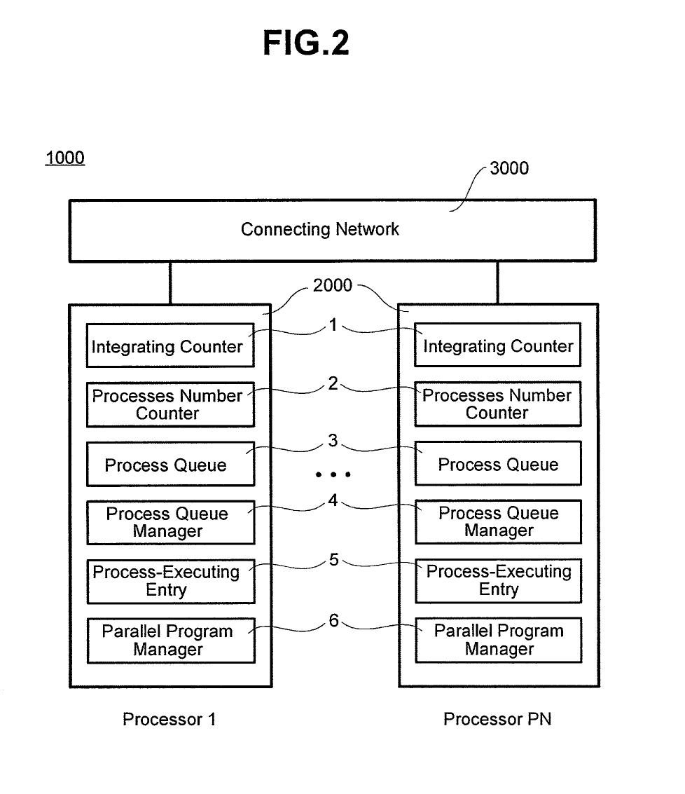

FIG. 2 shows an exemplary system of parallelprocessing computers in one preferred embodiment of the invention. The parallel-processing computers system 1000 of the present invention comprises N pieces of processors P1 to PN 2000 in a group interconnected by an connecting network 3000.

Each of the processors P1 to PN is equipped with an integrating counter 1, a processes number counter 2, a process queue 3, a process queue manager 4, and a process-executing entity 5.

In addition, part of or all the processors are equipped with a parallel program manager 6.

The integrating counter 1 increments over time in synchronization with all other processors and all the integrating counters of all processors are initialized to a value of the same origin when the system reboots. As an example of such counter, a time register that each processor has is disclosed in JP-A-281911/1995.

The processes number counter 2 is to store the number of processes to be executed by each processor. This number equals to the number of parallel programs running concurrently in the time-sharing manner in the system. The value of this counter may increase or decrease by the processing of the process queue manager 4.

The process queue 3 is to store the processes to be executed by each processor, which will be described later. Examples of the process queue 3 are given in FIGS. 7, 8, and 9.

An identifier that is unique within the system is determined for one parallel program and assigned to the parallel processes of the same parallel program.

The processes placed in the process queue 3 are arranged, according to the sequence of the identifiers assigned to the processes.

Specifically, the parallel processes of one of the parallel programs are placed in the process queues 3 of the processors in the corresponding position of order.

In the present embodiment of the invention, the identifiers are assigned by the parallel program manager 6, and an example thereof will be described later.

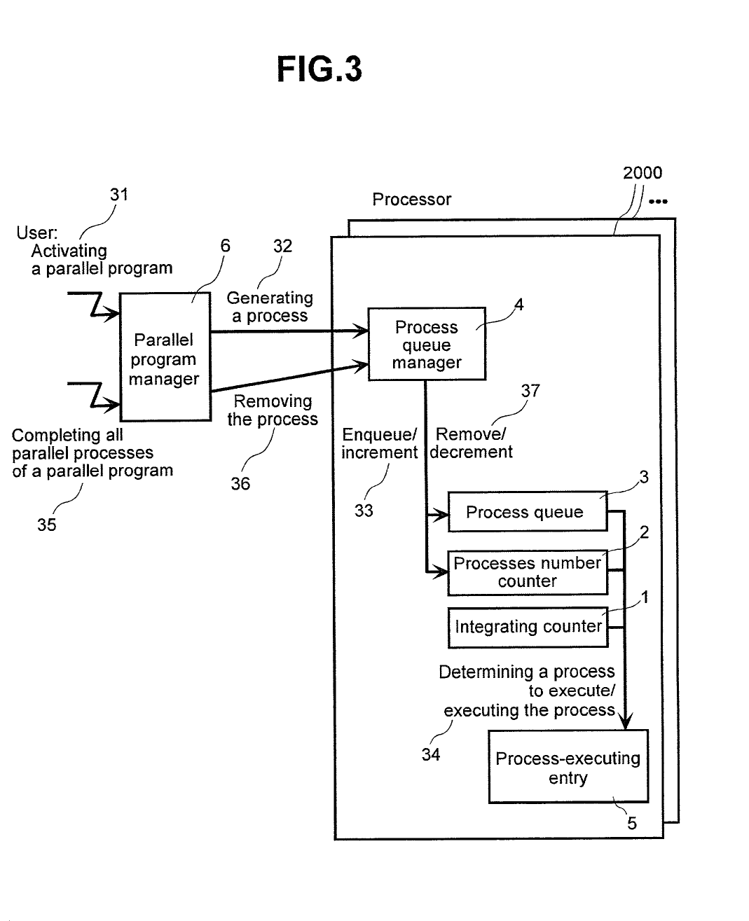

FIG. 3 is a schematic representation of the process flow of generating, executing, and deleting parallel programs in the embodiment of the present invention.

A request for activating a parallel program 31 from a system user is handled by any one of the parallel program managers 6 in the system. The parallel program manager 6 issues a request for generating a parallel process 32 of the parallel program to each processor. The process queue manager 4 of each processor enqueues the parallel process allocated in accordance with the process generation request into the process queue 3 and increments the processes number counter 2 (33). The parallel processes of the parallel program activated by the user, thus stored in the process queues 3 of the processors by the process queue managers 4, are executed by the process-executing entities 5. For each time slice, each process-executing entity 5 determines one of the processes stored in the process queue 3, according to the value of the integrating counter 1 and the value of the processes number counter 2 and executes that process during the time slice (34).

The process-executing entities 5 of the processors repeat process execution in the time-sharing manner until all parallel processes of a parallel program has been completed. Upon the completion of all parallel processes (35) of a parallel program, the parallel program manager 6 issues a request for removing the parallel process of the parallel program to each processor. In accordance with the request for removal, the process queue manager 4 of each processor removes the parallel process from the process queue 3 and decrements the processes number counter (37).

The first embodiment of the present invention will be further explained by referring to FIGS. 2, 4, 5, 7, 8, 10, 11, and 12.

The parallel processes of parallel programs are executed by the process-executing entities 5 of the processors in the parallel-processing computers system 1000.

If a time slice expires during the execution of a process, the execution of the process is stopped and a process is determined as the next to be executed, retrieved from the process queue 3, according to the integrating counter 1 and the processes number counter 2, and the next process is executed.

Because each process-executing entity 5 determines a process to execute per time slice and executes the process, sequence in which the parallel processes of the parallel programs are executed is determined by each processexecuting entity 5 of each processor.

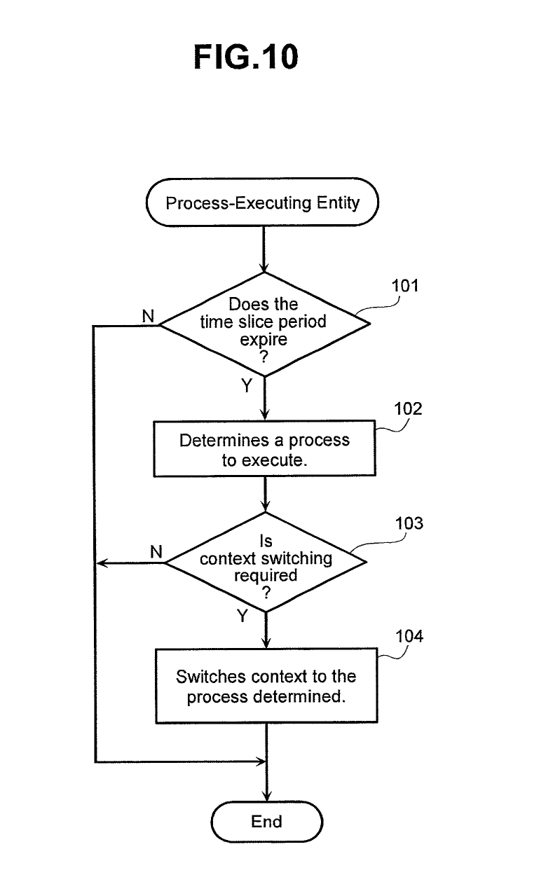

FIG. 10 is a flowchart illustrating the processing of the process-executing entity 5, which will be explained below.

This processing is activated by a timer interrupt that the system generates periodically.

By way of example, it is assumed that timer interrupts take place at intervals of 10 ms and the period of a time slice is 100 ms.

In step 101, the process-executing entity judges whether the time slice period expires when the local processor is executing a process. If the period does not expire, the process-executing entity terminates the processing. If the period expires, the process-executing entity goes to step 102.

In the step 102, the process-executing entity determines a process to execute, retrieved from the process queue 3, by referring to the integrating counter 1 and the processes number counter 2, then goes to step 103. To give an example of how to determine a process to execute, the process to execute is determined to be n-th process from the beginning of the process queue, where n is obtained by “(the value of integrating counter 1/time slice) mod the value of processes number counter 2.”

Hereupon, “P/Q” is to “divide P by Q and obtain a quotient” and “R mod S” is to “divide R by S and obtain the remainder.” The processing of the step 102 is exclusive with the processing of the process queue manager 4.

In the step 103, the process-executing entity judges whether switch processing to the next process to execute is required. If the switch processing is required, the process-executing entity goes to step 104. If not, the process-executing entity terminates the processing.

Judgment as to whether switching to the next process is required is made, depending on whether the process determined in the step 102 is the same one that was being executed during the time slice just now expired.

In the step 104, the process-executing entity switches the context to the process determined in the step 102 and starts to execute the process. After executing the process, the process-executing entity terminates the processing.

In the way described above, for a plurality of parallel programs, each consisting of the equal number of parallel processes, their parallel processes are allocated to each processor, and the process-executing entity 5 determines one of these processes to execute per time slice and executes the process.

In other words, the process-executing entity 5 of each processor determines sequence in which the queued processes are executed in time slices so that all parallel processes of one of the parallel programs are executed simultaneously and in turn.

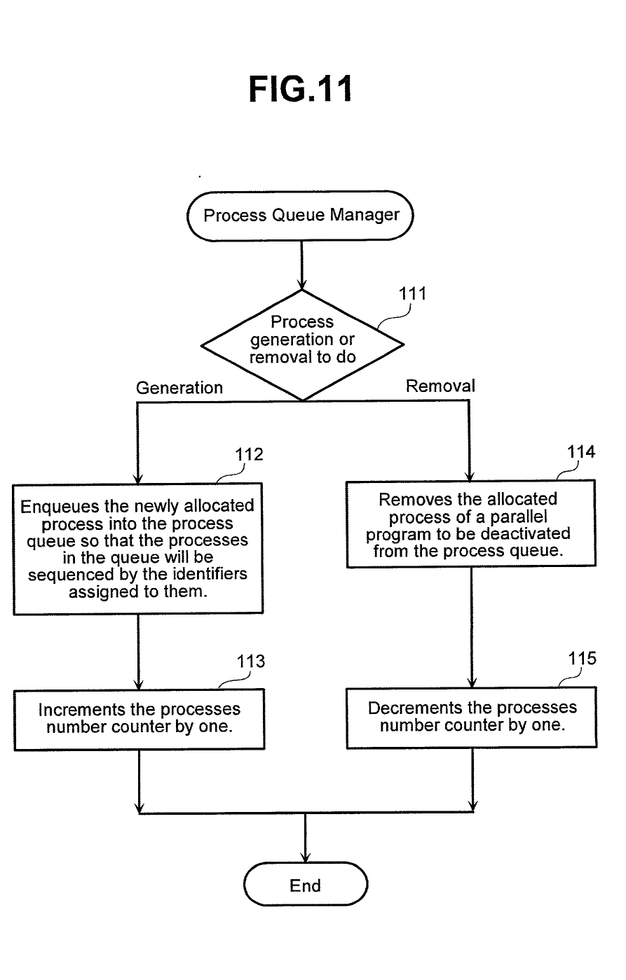

FIG. 11 is a flowchart illustrating the processing of the process queue manager 4, which will be explained below.

This processing is activated by process generation or removal processed by any parallel program manager 6 in the system. If a plurality of parallel program managers 6 perform process generation or removal of multiple programs at the same time, the process queue manager 4 sequentially performs the processing required for the multiple programs and this processing is exclusive with other processing.

Even if the process-executing entity 5 is determining a process to execute, the process queue manager operates exclusively with the process-executing entity 5.

In step 111, the process queue manager judges whether to do process generation or removal. For process generation, the process queue manager goes to step 112. For process removal, the process queue manager goes to step 114.

In the step 112, the process queue manager enqueues the newly allocated process of a parallel program to be activated into the process queue 3 so that the processes in the queue will be sequenced by the identifiers assigned to them, then goes to step 113.

In the step 113, the process queue manager increments the processes number counter 2 by one and terminates the processing. In the step 114, the process queue manager removes the allocated process of a parallel program to be deactivated from the process queue 3, then goes to step 115.

In the step 115, the process queue manager decrements the processes number counter 2 by one and terminates the processing.

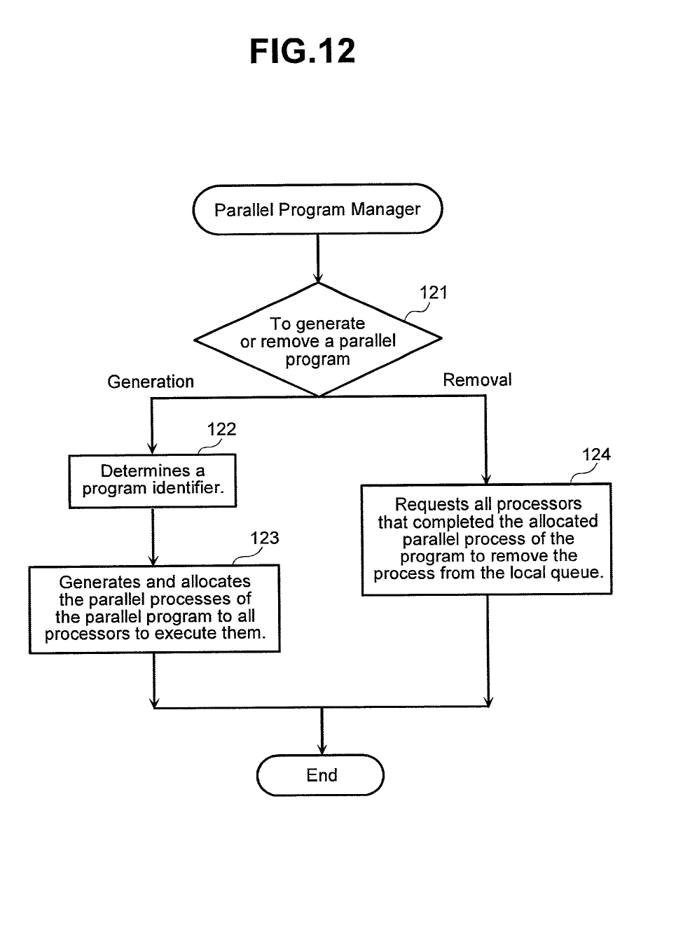

FIG. 12 is a flowchart illustrating the processing of the parallel program manager 6, which will be explained below.

The parallel program manager 6 is activated when a user of the system issues a request for generating a parallel program or on the completion of all parallel processes of one parallel program.

If requests for generating a plurality of parallel programs are issued to the same parallel program manager 6, the multiplex processing of these requests will take place concurrently in the parallel program manger of the processor.

In step 121, the parallel program manger judges whether to generate or remove a parallel program. For generation, the parallel program manger goes to step 122. For removal, the parallel program manager goes to step 124.

In the step 122, the parallel program manager determines an identifier that is unique within the system for the parallel program to be generated and assigns the identifier to the parallel processes of the parallel program. Then, the parallel program manager goes to step 123.

As an example, the following identifier scheme is used.

The parallel program manager 6 provided on each processor Pi (where i=1 to N) assigns a number staring with 0 up to 9999 to a parallel program.

This number assignment shall not be duplicated for the parallel programs being run, generated by the same parallel program manager 6.

Each parallel program manager 6 assigns the above number plus “10000×i” to the parallel processes of the parallel program as their identifier.

In the step 123, in accordance with the request for parallel program generation, the parallel program manager generates and allocates the parallel processes of the parallel program to the processors to execute them, then terminates the processing.

In the step 124, the parallel program manager requests all processors that completed the allocated process of the parallel program to remove the parallel process of the parallel program from the local queue, then terminates the processing. In consequence, the parallel processes of the parallel program executed on all processors will be removed.

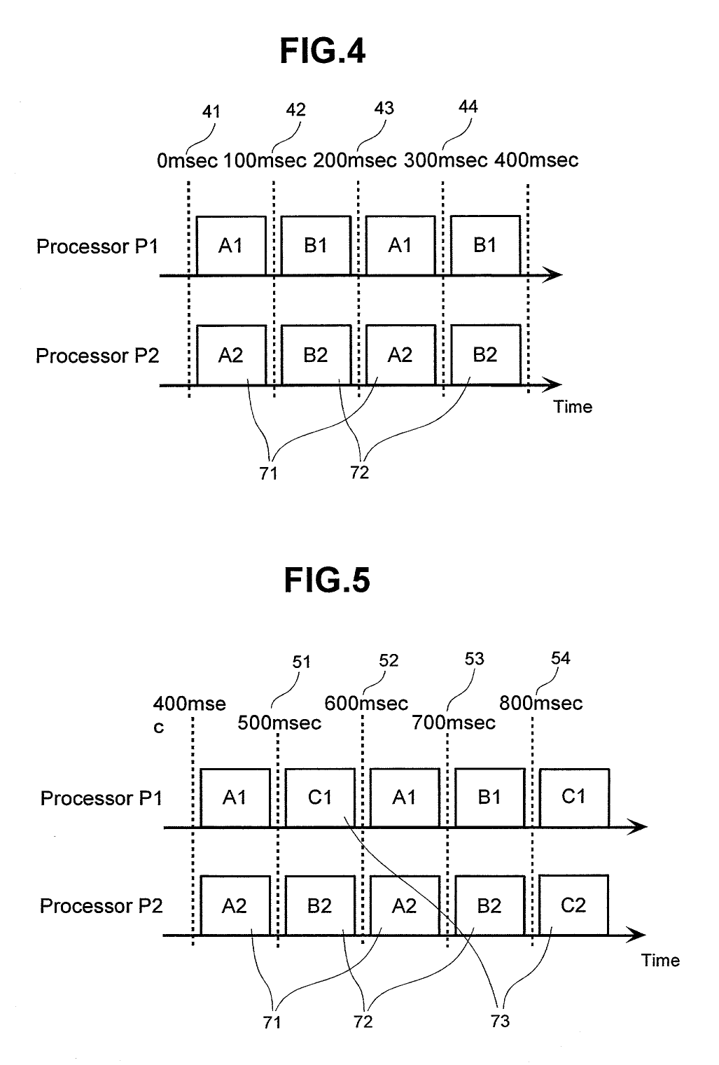

FIGS. 4 and 5 are diagrams giving examples of the transition of the processes to be executed on each processor over time when the parallel processes of a plurality of parallel programs are executed in the time-sharing manner in the first embodiment of the invention.

In these examples, the parallel programs are run on two processors P1 and P2. It is assumed that the time slice period is 100 ms and the time register is used as the integrating counter.

In the example of FIG. 4, two parallel programs 71 and 72 run, one consisting of two processes Al and A2 and the other consisting of two processes B1 and B2.

The allocated processes are placed in the process queue 3 on each processor as shown in FIG. 7: processes Al and B1 are placed in the process queue 3 of processor P1; and processes A2 and B2 are placed in the process queue 3 of processor P2.

The processes A1 and A2 are assigned identifier x and the processes B1 and B2 identifier y, placed in the process queues 3 of the processors.

Because the processes in the process queues 3 are sequenced by identifiers x and y assigned to them, the parallel processes of one of the parallel programs are in the corresponding position of order in the process queues 3 of the processors P1 and P2.

In this example, the processes are arranged, according to the sequence of identifiers x and y.

Returning to FIG. 4, at time 41, the process to execute is determined by “(0/100) mod 2=0.” Therefore, the 0th processes from the beginning of the process queues, namely, processes A1 and A2 of the parallel program 71 are executed on the processors P1 and P2, respectively.

Similarly, the processes to execute are determined and executed on the processors as follows. At time 42, processes B1 and B2 of the parallel program 72 are executed. At time 43, processes A1 and A2 of the parallel program 71 are executed again. At time 44, processes B1 and B2 of the parallel program 72 are executed again.

FIG. 5 is a diagram giving an example of the transition of the processes to be executed on each processor over time, wherein a new parallel program is generated and allocated when the parallel processes of two programs are executed in the time-sharing manner, according to the parallel processes run scheduling method of the present invention, all programs consisting of the equal number of parallel processes.

The parallel processes of a parallel program are not always generated or removed simultaneously on all processors to execute them.

In the example of FIG. 5, the number of processes being run on the processor P1 is three, whereas, that number on the processor P2 is two.

Because it is temporarily happens that the number of running parallel processes of the parallel program is different between the processors, the sequence of processes to run changes and simultaneous running of the parallel processes of the same parallel program becomes impossible momentarily. However, the simultaneous running of the parallel processes of the same parallel program recovers soon eventually without initiating the communication between the processors as will be described in the following example.

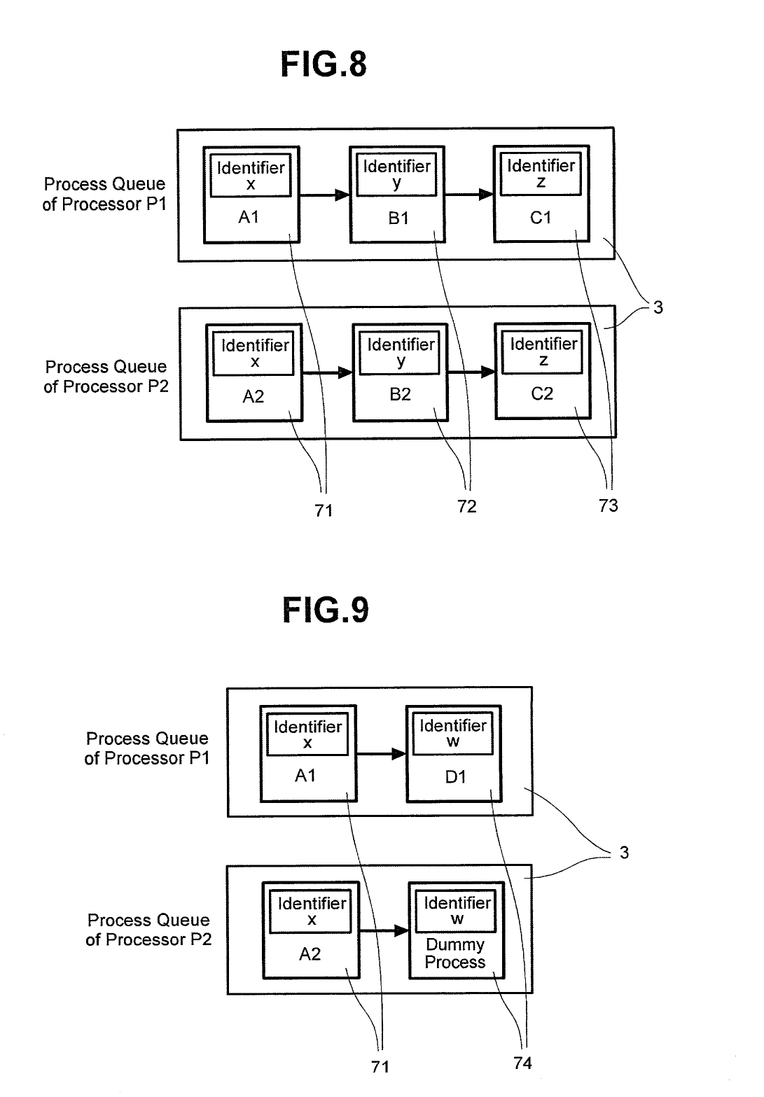

Assuming that three parallel programs 71, 72, and 73 are running, the first one consisting of two processes A1 and A2, the second one consisting of two processes B1 and B2, and the third one consisting of two processes C1 and C2, the process queues of the processors are as shown in FIG. 8 by way of example.

In the process queue 3 of processor P1, processes A1, B1, and C1 are placed. In the process queue 3 of processor 2, processes A2, B2, and C2 are placed.

The processes A1 and A2 are assigned identifier x, the processes B1 and B2 identifier y, and the processes C1 and C2 identifier z, placed in the process queues 3 of the processors.

Because the processes in the process queues 3 are sequenced by identifiers x, y, and z assigned to them, the parallel processes of one of the parallel programs are in the corresponding position of order in the process queues 3 of the processors P1 and P2.

In this example, the processes are arranged, according to the sequence of identifiers x, y, and z.

In the example of FIG. 5, at time 51, three processes A1, B1, and C1 are placed in the process queue of processor P1 as shown in FIG. 8, whereas two processes A2 and B2 are placed in the process queue of processor P2 as shown in FIG. 7. At time 51, the process to execute is determined by “(500/100) mod 3=2” on the processor P1 and therefore process C1 of the parallel program 53 is executed.

On the processor P2, the process to execute is determined by “(500/100) mod 2=1” and process B2 of the parallel program 72 is executed.

At time 52, the number of running processes becomes three for both processors P1 and P2 and the process queues of the processors are set in the states shown in FIG. 8.

At time 52, the process to execute is determined by “(600/100) mod 3=0” and therefore processes A1 and A2 of the parallel program 71 are executed on the processors P1 and P2, respectively.

On the processors P1 and P2, similarly, processes B1 and B2 of the parallel program 72 are executed at time 53 and processes C1 and C2 of the parallel program 73 at time 54, respectively.

Even if such temporary conditions that the number of running processes is different between the processors are caused by the generation or removal of parallel processes of a parallel program, the simultaneous running of the parallel processes of the same parallel program can be scheduled soon eventually without initiating the communication between the processors in the way described above.

In second embodiment of the present invention, it is assumed that parallel programs run, each consisting of the discrete number of parallel processes. In this case, when the parallel program manager 6 generates and allocates parallel processes of a parallel program, additionally, it generates dummy processes. The dummy processes are allocated to processors that are not to execute any parallel process of the parallel program and executed simultaneously with the parallel processes of the parallel program With reference to FIGS. 2, 6, 9, and 13, the second embodiment of the invention will be explained below.

The process queue manager 4 and the process-executing entity 5 perform the same processing as in the first embodiment.

Specifically, as is the case in the first embodiment, for parallel programs, each consisting of the discrete number of parallel processes, sequence in which their processes are executed is determined by the process-executing entity 5 of each processor so that all parallel processes of one of the parallel programs will be executed simultaneously and in turn.

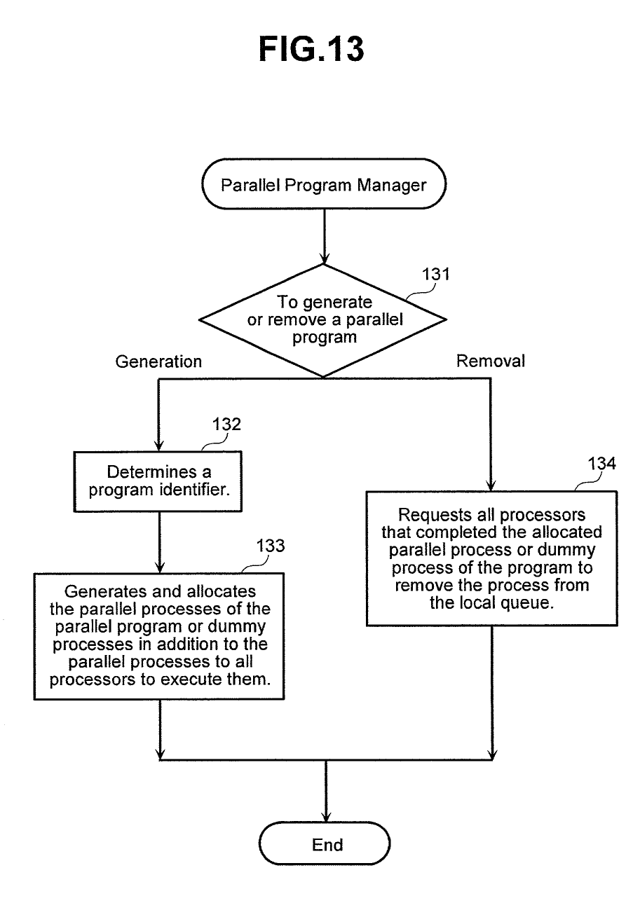

FIG. 13 is a flowchart illustrating the processing of the parallel program manager 6 in the second embodiment of the invention, which will be explained below.

In step 131, the parallel program manger judges whether to generate or remove a parallel program. For generation, the parallel program manger goes to step 132. For removal, the parallel program manager goes to step 134.

In the step 132, the parallel program manager assigns a program identifier that is unique within the system to the parallel processes of the parallel program, then goes to step 133.

In the step 133, if the number of the processes of a parallel program to be generated is less than the number of the processors to run the parallel program in the time-sharing-based multiplex manner, the parallel program manager generates as many dummy processes as required to fill up the difference in number in addition to generating the parallel processes of the parallel program in accordance with the request for parallel program generation and allocates the generated processes including the dummy processes to the processors, then terminates the processing. Otherwise, the parallel program manager generates and allocates the parallel processes of the parallel program to the processors and terminates the processing.

The dummy processes may be those that do nothing but create a spin loop.

The number of processes to constitute a parallel program is to be specified when the parallel program is complied or activated and the number of dummy processes to be generated can be determined, depending on the thus specified number of processes.

The dummy processes are assigned the same identifier as assigned to the parallel processes of the parallel program to be executed simultaneously.

In the step 134, the parallel program manager requests all processors that completed the allocated process or dummy process of the parallel program to remove the parallel process or dummy process of the parallel program from the local queue, then terminates the processing. In consequence, the parallel processes of the parallel program and the dummy processes executed simultaneously with the parallel processes will be removed.

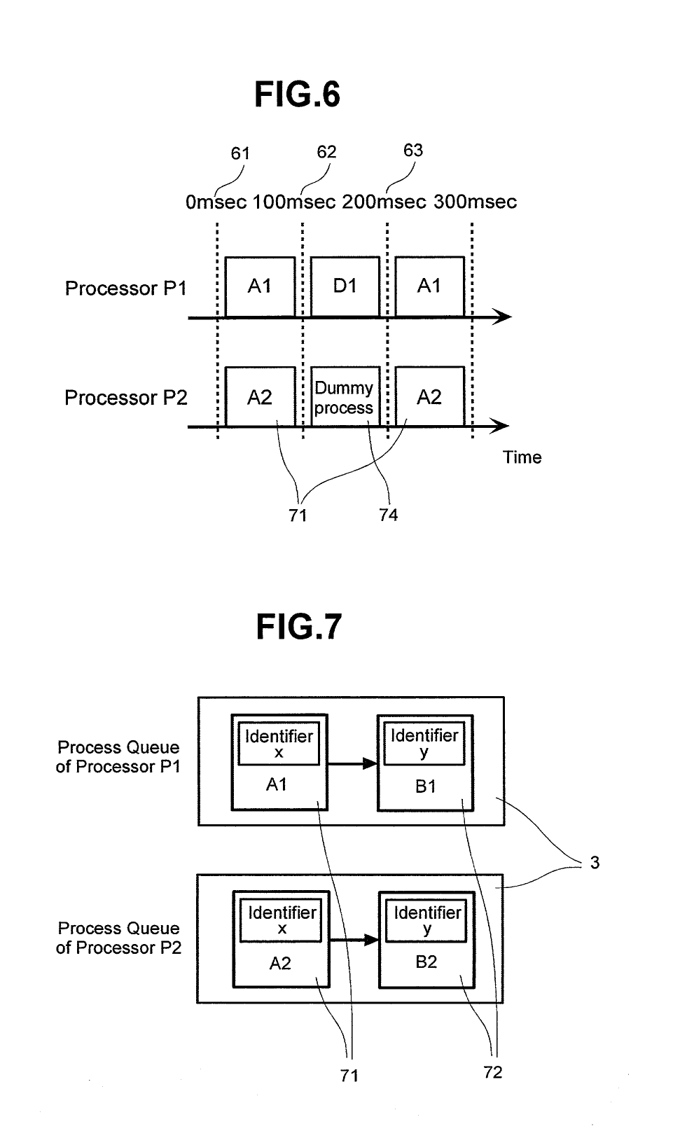

FIG. 6 is a diagram giving an example of the transition of the processes to be executed on each processor over time, wherein a dummy process is executed when a plurality of parallel programs, each consisting of the discrete number of processes, are executed in the timesharing-based multiplex manner in the second embodiment of the invention.

In this example, two parallel programs 71 and 74 run, one program 71 consisting of two processes A1 and A2 and the other program 74 consisting of one process D1. The processor P1 is shared for running the parallel programs 71 and 74.

The process queues of the processors are as shown in FIG. 9. In the process queue of the processor P1, processes A1 and D1 are placed. In the process queue of the processor P2, process A2 and a dummy process are placed.

The processes A1 and A2 are assigned identifier x and the process D1 and the dummy process identifier w, placed in the process queues 3 of the processors. Because the processes in the process queues 3 are sequenced by identifiers x and w assigned to them, the parallel processes of one of the parallel programs are in the corresponding position of order in the process queues of the processors P1 and P2.

In this example, the processes are arranged, according to the sequence of identifiers x and w.

Returning to FIG. 6, at time 61, the process to execute is determined by “(0/100) mod 2=0” and therefore processes A1 and A2 of the parallel program 71 are executed on the processors P1 and P2, respectively. At time 62, the process to execute is determined by “(100/100) mod 2=1” and therefore process D1 of the parallel program 74 is executed on the processor 1. At time 63, the process to execute is determined by “(200/100) mod 2=0” and therefore processes A1 and A2 of the parallel program 71 are executed again on the processors P1 and P2, respectively.

Moreover, on the processor P2, the dummy process is executed at time 62.

During the time-sharing execution of a plurality of parallel programs, each consisting of the discrete number of processes, when a processor is not executing a parallel process of a parallel program, instead, it executes a dummy process simultaneously with the parallel processes of the parallel program in the way described above. In this way, the simultaneous run of the parallel processes of one of the parallel programs can be scheduled in turn.

In accordance with the present invention, as explained above, it is feasible to schedule the run of parallel processes without requiring explicit processor-to-processor communication, thus reducing the overhead for coordination of the processors due to scheduling by coordinating the process-run steps of the processors.

The present invention may be embodied in other specific forms without departing from its spirit or essential characteristics. The described embodiments are to be considered in all respects only as illustrated and not restrictive. The scope of the invention is, therefore, indicated by the appended claims rather than by the foregoing description. All changes which come within the meaning and range of equivalency of the claims are to be embraced within their scope.

What is claimed is:

1. A parallel processes run scheduling method to be used in an information processing system comprising a plurality of processors on which a plurality of parallel programs, each consisting of the equal number of parallel processes, are run in a time-sharing-based multiplex manner, the method comprising:
the step of executing all allocated parallel processes on each processor in order as determined, according to the value of an integrating counter on each processor that increments over time in synchronization with all other processors and the number of the parallel programs to run concurrently in the system, thereby simultaneously executing the parallel processes of one of the parallel programs in turn on the processors.

2. A parallel processes run scheduling method to be used in an information processing system comprising a plurality of processors on which a plurality of parallel programs, each consisting of the discrete number of parallel processes, are run in a time-sharing-based multiplex manner, the method comprising:
the step of executing all allocated parallel processes on each processor in order as determined, according to the value of an integrating counter on each processor that increments over time in synchronization with all other processors and the number of the parallel programs to run concurrently in the system, wherein, if the number of the parallel processes of a parallel program is less than the number of processors to be used for running the parallel program in the time-sharing-based multiplex manner, some of the processors to which no parallel process of the parallel program is allocated execute a dummy process allocated instead when the parallel program is executed, thereby simultaneously executing the parallel processes of one of the parallel programs in turn on the processors.

3. A parallel processes run scheduling device to be used in an information processing system comprising a plurality of processors on which a plurality of parallel programs, each consisting of the equal number of parallel processes, are run in a time-sharing-based multiplex manner, the device to be provided on each processor comprising:
an integrating count means, the count value of which increments over time in synchronization with all other processors;
a processes number count means to store the number of processes to run on the processor, corresponding to the number of parallel programs to run in the system;
a means for generating a queue of processes to execute;
a process queue buffer means for storing the generated process queue; and
a means for determining a process to execute that determine a process to execute out of the processes in the process queue, according to the count value of the integrating count means and the number of processes retained in the processes number count means.

4. A parallel processes run scheduling device to be used in an information processing system comprising a plurality of processors on which a plurality of parallel programs, each consisting of the discrete number of parallel processes, are run in a time-sharing-based multiplex manner, the device to be provided on each processor comprising:
an integrating count means, the count value of which increments over time in synchronization with all other processors;
a processes number count means to store the number of processes to run on the processor, corresponding to the number of parallel programs to run in the system;
a means for generating a queue of processes to execute, wherein, if the number of processes allocated to the processor for executing them is less than the number of processes retained in the processes number count means, the means for generating a queue generates a queue of processes including as many dummy processes as required to fill up the difference in the number of processes of both; if the number of processes of both agrees, the means for generating a queue generates a queue of processes not including dummy processes;
a process queue buffer means for storing the generated process queue; and
a means for determining a process to execute that determine a process to execute out of the processes in the process queue, according to the count value of the integrating count means and the number of processes retained in the processes number count means.

5. A computer readable means having a parallel processes run scheduling program recorded thereon, comprising:
a procedure for counting and storing the number of processes to run on each processor, corresponding to the number of parallel programs specified to run in the system;
a procedure for generating and storing a queue of processes specified to be executed on each processor;
a procedure for determining a process to execute out of the processes in the process queue, according to the count value of the integrating count means of the processor and the number of processes corresponding to the number of parallel programs.

6. A computer readable medium having a parallel processes run scheduling program recorded thereon, comprising:
a procedure for counting and storing the number of processes to run on each processor, corresponding to the number of parallel programs specified to run in the system;
a procedure for generating and storing a queue of processes, wherein, if the number of processes specified to be executed on each processor is less than the number of processes counted, a queue of processes including as many dummy processes as required to fill up the difference in the number of processes of both is generated; if the number of processes of both agrees, a queue of processes not including dummy processes is generated;
a procedure for determining a process to execute out of the processes in the process queue, according to the count value of the integrating count means of the processor and the number of processes corresponding to the number of parallel programs.
